(19) United States
(12) Patent Application Publication
(10) Pub. No.: US 2007/0042339 A1
(43) Pub. Date: Feb. 22, 2007

(54) Preservation of biomaterials with transported preservation agents

(75) Inventors: Mehmet Toner, Wellesley, MA (US); Keishi Sugimachi, Cambridge, MA (US); Gloria Elliott, Beverly, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: MASSACHUSETTS GENERAL HOSPITAL, Charlestown, MA (US)

(21) Appl. No.: 10/563,774

(22) PCT Filed: Aug. 6, 2004
(86) PCT No.: PCT/US04/25469

§ 371 Date: Jul. 13, 2006

Related U.S. Application Data
(60) Provisional application No. 60/493,616, filed on Aug. 8, 2003.

(51) Int. Cl. A01N 1/02

(52) U.S. Cl. 435/2

(57) ABSTRACT

Biomaterial are preserved by exposing them to a preservation agent having preservation properties. The biomaterial has at least one transporter that allows uptake of the preservation agent into the biomaterial for loading the biomaterial with the preservation agent to an intracellular concentration sufficient for preserving the biomaterial. The preservation agent loaded biomaterial can then be prepared for storage, for example, by freezing, freeze drying, or drying.

### CROSS-REFERENCE TO RELATED APPLICATIONS

This application claims priority to, and incorporates herein by reference, U.S. Provisional Patent Application Ser. No. 60/493,616, filed on Aug. 8, 2003.

### STATEMENT REGARDING FEDERALLY SPONSORED RESEARCH

This work was partially supported by grants from the Defense Advanced Research Projects Agency/Naval Research Laboratories (N00173-01-1 G011) and the National Institute of Health (DK46270).

### FIELD OF THE INVENTION

The present invention relates to the preservation of biological material using transporter mechanisms to load intracellular protective agents to prepare the biological material for preservation.

### BACKGROUND OF THE INVENTION

Preservation and storage of living materials are becoming increasingly important in proportion to the recent development of tissue engineering and transplantation. Methods for the preservation of biological materials are employed in many clinical and veterinary applications where living material, including organs, tissues and cells, are harvested and stored in vitro for some period of time before use. Examples of such applications include organ storage and transplants, autologous and allogeneic bone marrow transplants, whole blood transplants, platelet transplants, embryo transfer, artificial insemination, in vitro fertilization, skin grafting and storage of tissue biopsies for diagnostic purposes. Preservation of primary hepatocytes is also of great importance given that major steps have been taken recently in the development of cell-based treatments for liver diseases, including bioartificial liver devices, hepatocyte transplantation, and ex vivo gene therapy. In order to fully reach their potential, isolated hepatocytes must be appropriately stored and transported for on demand utilization.

Methods currently employed for the preservation of cellular biological materials include immersion in saline-based media; storage at temperatures slightly above freezing; storage at temperatures of about −80° C.; and storage in liquid nitrogen at temperatures of about −196° C. The goal of all these techniques is to store biomaterial for an extended period of time with minimal loss of normal biological structure and function.

The viability of biological materials stored in saline-based media gradually decreases over time. Loss of viability is believed to be due to the build-up of toxic wastes, and loss of metabolites and other supporting compounds caused by continued metabolic activity. Using conventional saline-based media, living tissues can only be successfully preserved for relatively short periods of time. Examination of the microstructure of organs stored towards the upper limit of time shows degeneration, such as of mitochondria in heart muscle, and the performance of the organ once replaced is measurably compromised. For example, a human heart can only be stored in cold ionic solutions for about 5 hours following removal from a donor, thereby severely limiting the distance over which the heart can be transported.

When employing freezing techniques to preserve biological materials, high concentrations (approximately 10% by volume) of penetrating cryoprotective agents (CPAs), such as glycerol, dimethylsulfoxide (DMSO), glycols or propanediol, are often introduced to the material prior to freezing in order to limit the amount of damage caused to cells by the formation of ice crystals during freezing. The choice and concentration of cryoprotectant, time-course for the addition of cryoprotectant and temperature at which the cryoprotectant is introduced all play an important role in the success of the preservation procedure. Furthermore, in order to reduce the loss of cells, it is important that such variables as the rate and time-course of freezing, rate and time-course of thawing and further warming to room or body temperature, and replacement of cryoprotectant solution in the tissue mass with a physiological saline solution be carefully controlled. However, disadvantages of preserving biological materials in this way include: reduction of cell viability; potential toxic effects of the cryoprotectant to the patient upon re-infusion; and the high costs of processing and storage.

Small carbohydrates have also been reported to aid survival of variety of organisms, cells, and biomaterials from damage caused by freezing, freeze-drying, or desiccation. They are considered to help survival by decreasing the formation of lethal intracellular ice crystals, stabilizing cell membranes and proteins, and thereby preventing membrane and protein damage during freezing. Among these small carbohydrates, trehalose and sucrose have been shown to have excellent cryoprotective effects against stresses associated with freezing of mammalian cells. However, permeabilization of the plasma membrane is needed for large sugar molecules such as sucrose or trehalose to be present on both sides of membrane so that they may afford full protection.

Although there are several possible approaches for loading of sugars into cells such as thermotropic lipid-phase transition, genetic engineering, and protein engineering, these approaches suffer from being invasive and cumbersome. Glucose compounds have capability to overcome this problem because their uptake is specifically facilitated into mammalian cells through glucose transporter (GLUT), a superfamily of membrane proteins that mediate glucose transport, however, glucose is generally rapidly metabolized by the biological material of interest, making the glucose unavailable for preservation functions.

Thus, there remains a need in the art for improved methods for the preservation of biomaterials.

### SUMMARY OF THE INVENTION

The present invention provides methods for preserving biomaterials, such as cells, organs, tissues, and cell-lines. The invention is based, in part, on the discovery that biomaterials can possess transporter molecules, such as the glucose transporter (GLUT) protein, that can uptake preservation agents. Once these agents enter the biomaterial through the transporter molecule, they remain in the biomaterial at a concentration that provides protection during preservation.

Accordingly, in one aspect, the invention pertains to a method for preserving a biomaterial by exposing the biomaterial to a preservation agent having preservation properties. The biomaterial has at least one transporter that allows uptake of the preservation agent into the biomaterial for loading the biomaterial with the preservation agent to an intracellular concentration sufficient for preserving the biomaterial. The preservation agent loaded biomaterial can then be prepared for storage, for example, by freezing, freeze drying, or drying.

Thus, the present invention pertains to using non-metabolizable bio-preservation agents that are able to move into a biomaterial (e.g., a cell) using at least one transporter (e.g., a glucose transporter) and maintain the biomaterial in a preserved state. One non-limiting example of a non-metabolizable bio-preservation agent, is a non-metabolizable carbohydrate. Examples of non-metabolizable carbohydrates include, but are not limited to, non-metabolizable analogues of D-glucose (which can be transported by GLUT), non-metabolizable analogues of D-galactose (which can also be transported by GLUT), non-metabolizable analogues of D-mannose (which can also be transported by GLUT), non-metabolizable analogues of D-arabinose (which can also be transported by GLUT), and non-metabolizable analogues of sucrose (which can be transported by other transporters).

The biomaterial can be any cell or organism that has at least one transporter, e.g., a mammalian cell with a glucose transporter. The biomaterial can be selected from the group consisting of organs, tissues, isolated primary cells, stem cells, cell-lines, bone marrow, embryos, platelets, lymphocytes, hepatocytes, osteoblasts, spermatozoa, granulocytes, red blood cells, dendritic cells, oocytes, and plant cells. The invention is particularly useful for preservation of nucleated cells, as these cells often react poorly to conventional preservation protocols.

The transporter can be a selected from the group consisting of a glucose transporter (GLUT), a sucrose transporter, a mannose transporter, a galactose transporter, and a hexose transporter, or any combination thereof. In a preferred embodiment, the transporter is a glucose transporter (GLUT), which exist on all mammalian cells.

In one embodiment, the non-metabolizable bio-preservation agent is a non-metabolizable carbohydrate, such as non-metabolizable D-glucose analogues. Non-metabolizable D-glucose analogues can be selected from the group consisting of 3-O-methyl-glucose (3OMG), 2-deoxy-glucose (2DG), 6-deoxy-glucose (6DG), methyl α-D-glucoside, methyl β-D-glucoside, 1,6-anhydro-β-D-glucose, and 1,5-anhydro-D-glucitol. In a preferred embodiment, the non-metabolizable D-glucose analogue is 3-O-methyl-glucose (3OMG). In another preferred embodiment, the non-metabolizable D-glucose analogue is 2-deoxy-glucose (2DG). In another preferred embodiment, the non-metabolizable D-glucose analogue is methyl α-D-glucoside.

The non-metabolizable bio-preservation agent loaded biomaterial can be prepared for storage methods that include, but are not limited to, dry storage, cryopreservation, cold storage, hypothermic storage and desiccation.

In another aspect, the invention provides a method for preserving one or more mammalian cells that involves exposing one or more mammalian cells having a membrane and at least one transporter protein to a non-metabolizable preservation agent where the transporter protein is effective to transport the non-metabolizable preservation agent across the membrane to load the mammalian cells with the non-metabolizable preservation agent to a desired intracellular concentration sufficient for preserving the mammalian cells. The preservation agent loaded mammalian cells are then prepared for storage in a preserved state stored in the preserved state. At least a portion of the preservation agent loaded mammalian cells can then be recovered to a viable state.

In a still further aspect of the invention, a mammalian cell prepared for preservation is provided. The cell includes a cell membrane and a non-metabolizable carbohydrate loaded to a desired intracellular concentration sufficient to preserve the cell. The cell also includes a transporter protein effective to transport the non-metabolizable carbohydrate across the membrane to load the mammalian cell with the non-metabolizable carbohydrate to the desired intracellular concentration. The cell is further in a state selected from the group consisting of frozen and dry.

As further described below and in the claims, the various embodiments can be combined in a number of ways among the various aspects of the invention.

### BRIEF DESCRIPTION OF THE DRAWINGS

The invention will be more fully understood from the following detailed description taken in conjunction with the accompanying drawings, wherein:

FIG. 1 illustrates a method for preserving a biomaterial of the invention;

FIG. 2 illustrates the metabolic pathways of two non-metabolizable preservation agents (2DG and 3OMG) useful with the invention;

FIG. 3 illustrates the intracellular concentration of a preservation agent (3OMG) loaded within a biomaterial as an exemplary step in the method of FIG. 1, the concentration being measured using a radiolabeled agent;

FIG. 4 illustrates the percentage of dead cells after loading with non-metabolizable preservation agents of FIG. 2 as compared to loading with conventional preservation agents and a control;

FIG. 5 illustrates the metabolic activity of cells loaded with preservation agents, assessed using MTT reduction activity;

FIG. 6 illustrates the viability of cryopreserved mammalian cells loaded with the preservation agents of FIG. 2 as compared to a control;

FIG. 7 illustrates the viability of cryopreserved mammalian cells with different glucose compounds and sucrose;

FIG. 8 illustrates cell survival as a function of residual water in the sample after drying for cells loaded with 3OMG and a control;

FIG. 9A illustrates the kinetics of 3OMG uptake and efflux on hepatocytes (Hepatocytes were incubated with 200 mM 3OMG for 60 min, and then washed with sugar-free medium for 30 min. Samples were collected at different time points. The amount of intracellular 3OMG was normalized to total protein amount. Values are the means±s.e. for at least 5 replicates.);

FIG. 9B illustrates cell viability (black bar) and metabolic activity (white bar) of hepatocytes after incubation with various sugars for 60 min (Cells incubated in sugar-free medium were used as control, and the values were shown as the means±s.e. percentage of the controls (n=9).);

FIG. 10A illustrates post-thaw viability of cryopreserved hepatocytes (The protective abilities of 3OMG, 2DG, sucrose, and D-glucose were evaluated by the viability of frozen-thawed hepatocytes loaded with various sugars. The values were shown as the means±s.e. percentage of the non-frozen controls for at least 6 replicates. The viability of 3OMG-loaded hepatocytes was higher than each of the other groups (*p<0.01).);

FIGS. 10B-E illustrate typical phase-contrast images of cryopreserved hepatocytes at 48 hrs after thawing (Cells were seeded and cultured in a collagen sandwich culture. No-glucose control (B), sucrose-loaded (C), and D-glucose-loaded (D) hepatocytes remained in spheroid shape, while 3OMG-loaded cells (E) attached and well spread. (Original magnification ×100));

FIGS. 10F-G illustrate rhodamine phalloidin staining of cryopreserved hepatocytes ((Original magnification ×400) (F) No-glucose control hepatocytes completely lost polarity and structure. (G) Actin filaments (F-actin) were found at their normal sites at both the lateral intercellular contacts and the apical canalicular membrane in 3OMG-loaded hepatocytes.);

FIGS. 11A-B illustrate albumin (A) and urea (B) production by frozen-thawed 3OMG-loaded hepatocytes (closed circle) and non-frozen control hepatocytes (open circle) (Cells were cultured in a collagen sandwich culture for 14 days, and media collected daily were analyzed for albumin and urea. 3OMG-loaded hepatocytes maintained high synthetic functions and they were comparable to non-frozen control. All values were normalized by viable cell number (DNA content) and shown as the means±s.e. (n=9)); and

FIG. 11C illustrates cytochrome P450 activity of 3OMG-loaded hepatocytes (black bar) and non-frozen control hepatocytes (white bar) on day 3 and 7. (n-9) 3OMG-loaded and cryopreserved hepatocytes retained comparable detoxification activity to non-frozen control hepatocyte.

### DETAILED DESCRIPTION OF THE INVENTION

The methods and compositions of the present invention may be used in the preservation of biomaterials such as mammalian cells, plant cells, and marine cells, cell-lines, tissues, organs, and the like. When a biomaterial is preserved, its viability is maintained in vitro for an extended period of time, such that the biomaterial resumes its normal biological activity on being removed from storage. During storage the biomaterial is thus maintained in a reversible state of dormancy, with metabolic activity being substantially lower than normal.

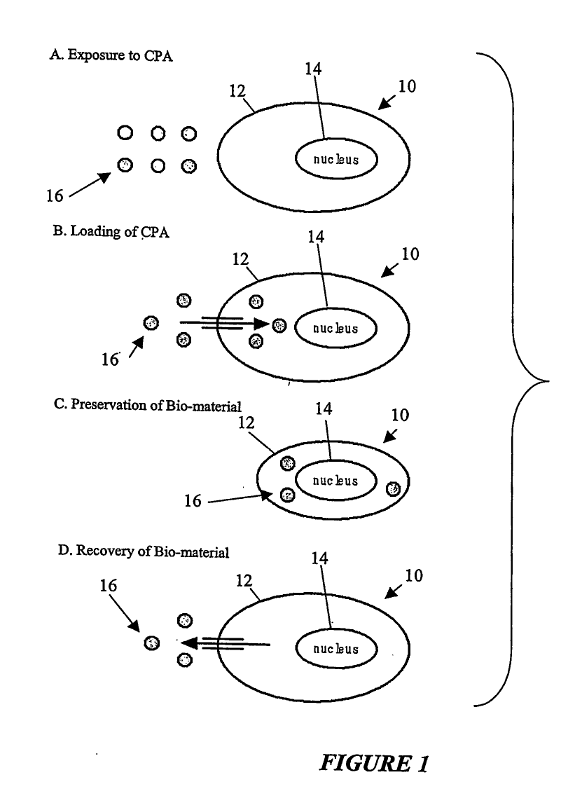

In a method of the invention, the biomaterial to be preserved are selected and prepared for preservation by loading it with a bio-preservation agent or cryoprotective agent (CPA; or collectively, a preservation agent or simply an agent). As illustrated in step (A) of FIG. 1, the biomaterial 10 so selected is first exposed to the preservation agent 16. The preservation agent 16 is preferably a non-metabolizable preservation agent that is able to move into the biomaterial 10—the biomaterial 10 generally having a membrane 12 (e.g., one or more cells 10 having a cell membrane 12, and possibly also a nucleus 14) using at least one transporter (e.g., a glucose transporter) that is effective to move the preservation agent across the membrane 12 into the biomaterial 10 as illustrated in step (B) of FIG. 1. Once inside the biomaterial 10 at a concentration that provides protection during preservation or storage of the biomaterial, the non-metabolizable bio-preservation agent 16 keeps the biomaterial in a preserved state as illustrated in step (C) of FIG. 1 when the biomaterial is stored. As also shown in step (D) of FIG. 1, the biomaterial 10 can be recovered from the preserved state in a viable condition. This step may include a process for removing some or all of the non-metabolizable bio-preservation agent 16 from the biomaterial 10 by removing it across membrane 12.

Examples of biomaterials which may be preserved using the present invention include, but are not limited to, organs, such as heart, kidneys, lungs and livers; cells and tissues such as hematopoietic and embryonic stem cells, bone marrow, embryos, platelets, osteoblasts, spermatozoa, granulocytes, red blood cells, dendritic cells, oocytes; and various animal cell lines established in tissue culture. The invention is particularly useful for difficult to preserve biomaterials including living nucleated cells, and in particular, mammalian cells such as fibroblasts, hepatocytes, chondrocytes, keratinocytes, islets of Langerhans, granulocytes, and hematopoietic and embryonic stem cells. In addition to the preservation of human biomaterials, the inventive solutions and methods may also be employed in veterinary applications, and for preservation of plant and marine tissues.

In a preferred embodiment of the invention, the biomaterial to be preserved includes one or more cells, with each cell having a cell membrane and one or more transporter molecules, typically transporter proteins, that are capable of transporting the CPA across the cell membrane. A description of some transporter proteins that can be effective in a method or composition of the invention are described below in the section labeled Transporter Molecules. Such a biomaterial can be exposed to a CPA as illustrated in step (A) of FIG. 1.

Most traditional cryopreservation protocols include the addition of 1.0-2.0 M of penetrating cryoprotectants (CPAs) such as DMSO, glycerol, and ethylene glycol. However, using the method of the invention, small carbohydrate sugars such as trehalose (a nonreducing disaccharide of glucose), glucose, sucrose, and maltose, may be loaded to concentrations less than or equal to about 1.0 M, preferably less than or equal to about 0.4 M, and most preferably, less than or equal to about 0.2 M sugar. Glucose and other metabolisable small carbohydrate sugars can be excellent bio-preservation agents, however, they are typically metabolized by the cells to be preserved and are thus unavailable for bio-preservation. In one embodiment of the invention, the preservation agent is a non-metabolizable form of such a sugar for which a transporter protein is available to uptake the preservation agent into the biomaterial for loading to the desired concentration. In this embodiment, the invention provides the benefits of the excellent preservation characteristics of small carbohydrate sugars, while further taking advantage of transporter protein uptake protocols that greatly improve the loading of these bio-preservation agents.

The solution applied to the biomaterial for preservation illustrated in step (A) of FIG. 1 can include differing non-metabolizable preservation agents mixed together or in solution with other traditional bio-preservation agents, other small carbohydrate preservation agents, or metabolizable preservation agents. It is also possible that new bio-preservation agents will be synthesized specifically for intracellular application in the method described herein or in further combinations. Further information on non-metabolizable preservation agents useful with the invention is provided below in the section entitled Non-Metabolizable Preservation Agents.

As a result of the preservation agent of the invention being exposed to a biomaterial having transporter molecules therein, the biomaterial uptakes the preservation agent to an intracellular level sufficient to provide bio-preservation effects to the biomaterial as illustrated in step (B) of FIG. 1. As described in the examples below, exposing such a biomaterial to a 0.2 M preservation solution results in an intracellular concentration of the preservation agent that is slightly below 0.2 M.

It may also be beneficial to add certain high molecular weight bio-preservation agents that are not taken up into the biomaterial. One such agent is raffinose. Raffinose attracts water that may diffuse into the biological material by forming a pentohydrate and stabilizes the glassy state against increases in moisture content (e.g., though cracked vials, etc.). Dextran of various molecular weights, having good glass formation properties, may be used extracellularly to allow increases in the storage temperature of a frozen stored sample. Other large molecules that are not taken up into the biomaterial may also be used extracellularly with the method of the invention to enhance the outcome of a particular preservation protocol.

Following the preservation agent loading step, the biological material is prepared for storage and stored with the preservation agent loaded within the biomaterial as illustrated in step (C) of FIG. 1. A variety of methods for freezing and/or drying may be employed to prepare the material for storage. In particular, three approaches are described in U.S. Pat. No. 6,127,177 to Toner et al. (incorporated herein by reference) may be used herein without limitation: vacuum or air drying or desiccation, freeze drying, and freeze-thaw protocols. Drying processes have the advantage that the stabilized biological material may be transported and stored at ambient temperatures. When frozen, the biomaterial is stored at appropriate temperatures as is known in the art.

Recovery of viable cells, step (D) of FIG. 1, may also be performed as in known in the art, including the methods described in U.S. Pat. No. 6,127,177, without limitation.

Transporter Proteins

In one aspect, the invention pertains to using transporter molecules, more particularly transporter proteins, to uptake a non-metabolizable bio-preservation agent (e.g., a non-metabolizable carbohydrate) into a biomaterial. In a preferred embodiment, the transporter protein is a glucose transporter (GLUT) protein. Most mammalian cells transport glucose through a family of membrane proteins known as glucose transporters (GLUT or SLC2A family). Molecular cloning of these glucose transporters has identified a family of closely related genes that encodes at least 9 proteins (GLUT-1 to GLUT-14, molecular weight 40-60 kDa). Individual member of this family have identical predicted secondary structures with 12 transmembrane (TM) domains. Both N and C-termini are predicted to be cytoplasmic. There is a large extracellular domain between TM1-TM2 and a cytoplasmic domain between TM6-TM7. Most differences in sequence homology exist within the four hydrophilic domains that may play a role in tissue-specific targeting. GLUT isoforms differ in their tissue expression, substrate specificity and kinetic characteristics. GLUT-1 mediates glucose transport into red cells, and throughout the blood brain barrier. It is ubiquitously expressed and transport glucose in most cells. GLUT-2 provides glucose to the liver and pancreatic cells. GLUT-3 is the main transporter in neurons, whereas GLUT-5 is primarily expressed in muscle and adipose tissue and regulated by insulin. GLUT-5 transports fructose in intestine and testis. GLUT-6 name was previously assigned to a pseudogene. Now GLUT-9 has been renamed as GLUT-6 (human 507 amino acids; ˜45% identity with GLUT-8). It is highly expressed in brain, spleen, and leukocytes. GLUT-7, expressed in liver and other gluconeogenic tissues, mediates glucose flux across endoplasmic reticulum membrane. Most recently, GLUT-8 (mouse/rat/human 477 amino acids, ˜30% identity with GLUT-1) has been cloned and characterized. High levels are found in adult testis and placenta. Human GLUT-9 (540 amino acids; chromosome 4p15.3-p16) is approx 45% identical with GLUT-5, and 38% with GLUT-1. It is expressed in kidney, followed by liver. GLUT-9 is also detected in placenta, lung, blood leukocytes, heart, and skeletal muscle. Human GLUT-10 (541 amino acids, chromosome 20q13.1; 30-35% homology with GLUT-3 and GLUT-8) has been identified as a candidate gene for NIDDM susceptibility. It is widely expressed with highest levels in liver and pancreas. GLUT-11 (496 amino acids, chromosome 22q11.2; ˜41% identity with GLUT-S) is expressed in heart and skeletal muscle. Recently, a few novel members of GLUT family have been identified. GLUT-12 (human 617 amino acids; 29% identity with GLUT-4 and 40% with GLUT-10). It is expressed in skeletal muscle, adipose tissue, and small intestine. GLUT-13 or H+ myo-inositol transporter (HMIT, rat 618 amino acids; human 629 amino acids; 36% identity with GLUT-8). It is predominantly expressed in brain.

Details for the various GLUT proteins can be found for example for GLUT-1 in Mueckler et al (1985) Science 229, 941-985; and Fukumoto, et al (1989) Diabetes 37, 657-661. GLUT-2: Fukumoto et al (1989) J. Biol. Chem 264, 7776-7779; GLUT-3: Kayano et al (1988) J. Biol. Chem 263, 15245-15248; GLUT-4: Fukumoto et al (1989) J. Biol. Chem 264, 7776-7779; Buse et al (1992) Diabetes 41, 1436-1445; Chiaramonte, et al (1993) Gene 130, 307-308; and Choi et al (1991) Diabetes 40, 1712. For GLUT-5: Kayano et al (1990) J. Biol. Chem 265, 13276-13282; GLUT-6: Doege et al (2000) Biochem. J. 350, 771-776; GLUT-7: Waddell et al (1992) Biochem. J. 286, 173-177; GLUT-8: Carayannopoulos et al (2000) Proc. Natl. Acad. Sci. 13, 7313-7318; Doege et al (2000) J. Biol. Chem 275, 16275-16280; and Ibberson et al (2000) J. Biol. Chem 275, 4607-4612. For GLUT-9: Phay et al (2000) Genomics 66, 217-220; GLUT-10: McVie-Wylie et al (2001) Genomics 72, 113-117; GLUT-11: Doege et al (2001) Biochem J. 359, 443-459; GLUT-12: Rogers et al (2002) Am. J. Endocrinol. Metabol. 282, E733-E738; and for GLUT-13: Uldry et al (2001) EMBO J. 20, 4467-4477.

These glucose transporter (GLUT) proteins are most often configured in the cells such that the direction of movement of glucose is usually out to in, and are most active with D-glucose, D-galactose, D-mannose and several other D-sugars. Although D-glucose is considered to function as a bio-protectant (Storey et al. (1994) Am J Physiol 266:R1477-82) and it can be transported through GLUT, it is rapidly metabolized by glycolysis in living cells, which prevents accumulation of enough quantities to afford protection. Additionally, loading D-glucose is considered to be harmful to organ probably due to hypermetabolism (Hopkinson et al. (1996) Transplantation 61:1667-71). It is known that there are several compounds which are transported through GLUT mimicking D-glucose, but not metabolized in the cells. The well-described and representative compound of non-metabolizable compound is 3-O-methyl-glucose (3OMG) (Longo et al. (1988) Am J Physiol 254:C628-33), and 2-deoxy-glucose (2DG) (Siddiqi et al. (1975) Int J Cancer 15:773-80).

In another embodiment, the transporter proteins is a sucrose transporter protein. The regulation of sucrose transport in plants has a major impact on plant growth and productivity. Through photosynthesis, plants fix atmospheric carbon dioxide into triose phosphates, which are then used to produce sucrose and other carbohydrates. These carbohydrates are then transported throughout the plant for use as energy sources, carbon skeletons for biosynthesis and storage for future growth needs. Sucrose is the major form of transported carbohydrate. Sucrose is loaded into the phloem by a proton/sucrose symporter located in the phloem plasma membrane and then distributed throughout the plant. The ability of plant cells actively to transport sucrose across the plasma membrane so that the sucrose that is mobilized in the phloem can be taken into cells for use is a critical step in sucrose utilization (Riesmeier et al. (1993) Plant Cell. 5:1591-1598; Hirose, et al. (1997) Plant Cell Physiol. 38:1389-1396).

Various transporter proteins responsible for transporting substances through membranes have already been identified in plants, and in some cases DNA sequences which code for such transporter proteins are available. cDNA sequences which code for plant sucrose transporters have been described, for example for potatoes (p 62 and StSUT1) and spinach (S21 and SoSUT1) (WO 94/00574; Riesmeier et al., (1993) Plant Cell 5:1591-1598; Riesmeier et al., (1992) EMBO J. 11: 4705-4713), for Arabidopsis thaliana (suc1 and suc2 genes; EMBL gene bank: Access No. X75365), Plantago major (EMBL gene bank: Access No. X75764), L. esculentum (EMBL gene bank: Access No. X82275) and Nicotiana tabacum (EMBL gene bank: Access Nos. X82276 and X82277). In the case of the sucrose transporters, it was possible to clone cDNA sequences coding for these transporters from spinach and potato by developing an artificial complementation system in Saccharomyces cerevisiae (Riesmeier et al. (1992) EMBO J. 11: 4705-4713; Riesmeier et al., (1993) Plant Cell 5: 1591-1598). It has likewise been possible to show for the sucrose transporter that a reduction in the activity leads to a great inhibition of growth of potato plants. Furthermore, the leaves of the affected plants are damaged, and the plants produce few or no potato tubers (Riesmeier et al. (1994) EMBO J. 13: 1-7).

In yet another embodiment, the transporter protein is a mannose transporter protein. Many sugars are transported into E. coli by phosphoenolpyruvate-dependent phosphotransferase systems (PTS). Such sugars include glucose, fructose, mannose, galactitol, mannitol, sorbitol, xylitol and N-acetylglucosamine. They are phosphorylated as they are transported into the cell. For example, glucose enters the cell as glucose-6-phosphate. The phosphate group is transferred from phosphoenol pyruvate (PEP) through a series of intermediary proteins some of which are common to all PTS sugar transport systems and some of which are specific for an individual PTS sugar transport system. The former include EI and HPr; the latter is the EII complex which has several functional domains that may or may not exist as separate or distinct entities.

The skilled artisan will appreciate that the transporter protein can be any carbohydrate protein which in addition to the above discussed transporter proteins, also includes, but is not limited to, fructose transporter protein, galactose transporter protein, hexose transporter protein, arabinose transporter protein, and the like.

Also within the scope of the invention are methods and compositions for preserving biomaterials using combinations of transporter proteins and different non-metabolizable preservation agents. For example, a cell may be preserved by using at least one GLUT transporter protein that uptakes a non-metabolizable glucose analogue, and at least one mannose transporter protein that uptakes a non-metabolizable mannose analogue. In certain embodiments of the invention, there are at least two different transporter proteins in the cell that can be used to uptake at least two different non-metabolizable agents, such as two different non-metabolizable carbohydrates, preferably about three different transporter proteins that uptake three different non-metabolizable agents, preferably about four different transporter proteins, about five different transporter proteins, about six different transporter proteins, about seven different transporter proteins, about eight different transporter proteins, about nine different transporter proteins, about ten different transporter proteins, most preferably about 10 to about 12, 14, 16, 18, 20, 22, 24, 26, 28, and 30 different transporter proteins.

In addition, the transporter protein or other transporter molecule can present in the biomaterial naturally, or the biomaterial can be genetically or otherwise altered to contain the transporter molecule.

Non-Metabolizable Preservation Agents

In one aspect, the invention pertains to preserving biomaterial using non-metabolizable preservation agents. The non-metabolizable agent enters a biomaterial through at least one transporter molecule and remain within the cell in a non-metabolizable form at a concentration that provides protection for the biomaterial. That is, the agent used for this purpose must not metabolize faster than the time required for the agent to be loaded into the biomaterial and for the biomaterial to be prepared for preservation. Similarly, the agent should not metabolize while the biomaterial is being stored in a dormant or preserved state.

One non-limiting example of a non-metabolizable agent is a non-metabolizable carbohydrate. These non-metabolizable carbohydrates can be analogues of D-glucose that include, but are not limited to, 2-deoxy-D-glucose, 3-deoxy-D-glucose, 6-deoxy-D-glucose, methyl α-D-glucoside, methyl β-D-glucoside, 1,6-anhydro-β-D-glucose, and 1,5-anhydro-D-glucitol. These non-metabolizable analogues of D-glucose can be transported by the GLUT receptor.

Other examples of non-metabolizable carbohydrate compounds include non-metabolizable analogues of D-galactose (which can also be transported by GLUT), and which include, but are not limited to, 3,6-anhydro-D-galactose, methyl α-D-galactoside, methyl β-D-galactoside, and 6-deoxy-D-galactose. Examples of non-metabolizable analogues of D-mannose (which can also be transported by GLUT) include, but are not limited to, α-methyl D-mannoside. Examples of non-metabolizable analogues of D-arabinose (which can also be transported by GLUT) include, but are not limited to, 2-deoxy-D-arabinose. Examples of non-metabolizable analogues of sucrose (which can be transported by other transporters) include, but are not limited to, D-turanose (3-O-α-D-glucopyranosyl-D-fructose), and palatinose (6-O-α-D-glucopyranosyl-D-fructofranose).

To achieve a desired concentration of glucose compounds for purposes of the invention, i.e. to preserve a biomaterial, non-metabolizable glucose compounds can be used as a protetant. Glucose is more ideal and less invasive to the cells compared to conventional penetrating cryoprotectants, such as dimethyl sulfoxide (DMSO) or glycerol. Although not bound by any theory of action, the non-metabolizable glucose compounds such as 3-O-methyl-D-glucose (3OMG) and 2-deoxy-D-glucose (2DG) are transported into cells through GLUT (Longo et al. (1988) Supra; and Siddiqi et al. (1975) Supra). They accumulate in the cells without undergoing any metabolic pathway and function as a protectant during storage. Cells are thawed or rehydrated after the storage, and glucose compounds are washed out through GLUT. Therefore cells can avoid toxicity due to high concentration of glucose compounds after recovery. GLUT is a physiological transporter of cells and expresses in all kinds of mammalian cells. Thus using non-metabolizable glucose and GLUT is considered to be less invasive and more applicable than conventional methods, which can apply for not only cultured cells but also tissues and in vivo organs. From these points, the invention provides a method that can be beneficial and a standard for preservation of biomaterials.

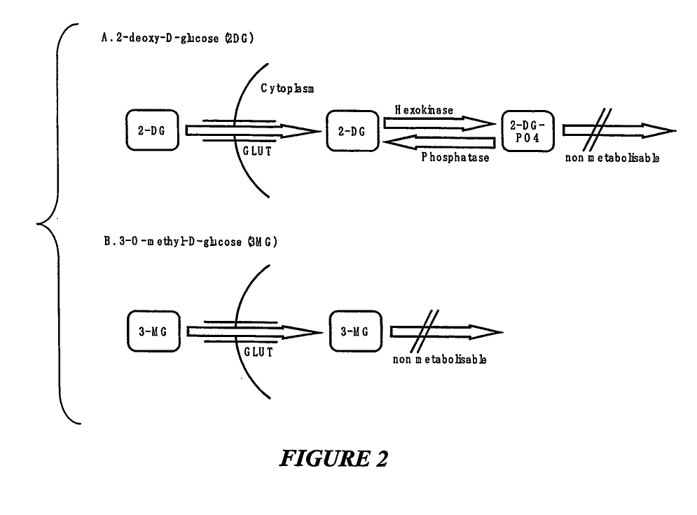

In a preferred embodiment, the non-metabolizable carbohydrate is a 3-O-methyl-D-glucose (3OMG) comprising Formula I. 3OMG is a non-metabolizable sugar, and it does not undergo any reaction in the cells as illustrated in pathway (B) of FIG. 2B. (Longo et al (1988) Supra). It goes into cells through GLUT and equilibrates between intra and extra cellular concentration. Also within the scope of the invention, are metabolizable carbohydrates with modifications to Formula I.

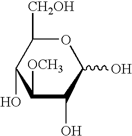

In another preferred embodiment, the non-metabolizable carbohydrate is 2-deoxy-D-glucose (2DG) comprising Formula II. 2DG enters the cell through GLUT and is phosphorylated by hexokinase. 2DG-6-PO4 is unable to undergo further metabolism, so high level of 2DG-6-PO4 cause allosteric and competitive inhibition of hexokinase, which results in accumulation of 2DG as illustrated in pathway (A) of FIG. 2. (Aft et al. (2002) Br J Cancer 87:805-12). 2DG is also reported to up-regulate GLUT protein, which results in increased uptake of glucose.

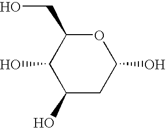

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

### EXAMPLES

### Example 1

### Comparison of Preservation Agents and Effects on Different Cells Loading of Glucose Compounds

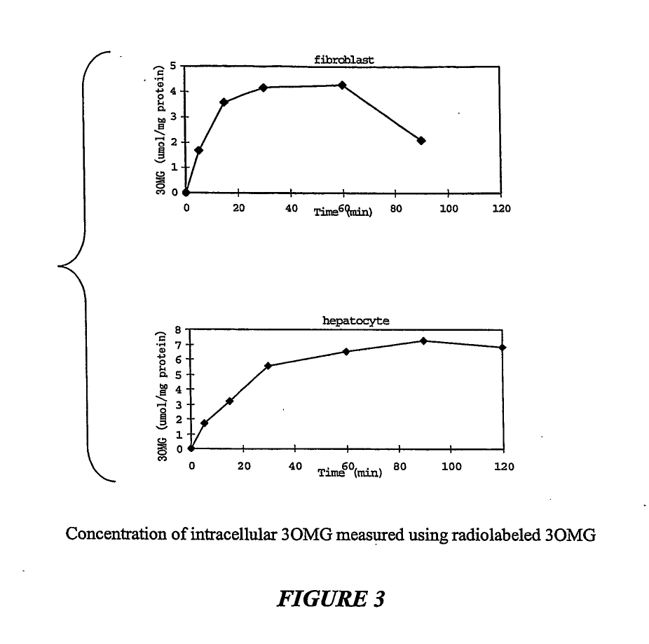

To determine the intracellular concentration of glucose compounds after loading, kinetics of glucose uptake was examined. Cells were incubated for desired time (up to 120 min) in DMEM containing 0.2 M 3OMG and 10 μCi/ml 3[³H]OMG at 37° C. To terminate uptake, cells were washed three times with ice-cold stop solution, and cells were solubilized in 0.4 ml 0.2 N NaOH, and an aliquot was taken for determination of uptake using liquid scintillation counter. Uptake was normalized by total protein amount of each sample. The result showed time-dependent accumulation of glucose compounds in the cells (FIG. 3). On both fibroblasts and hepatocytes, the amount of intracellular 3OMG reached a plateau in 60 min. The calculated concentration of intracellular 3OMG was about 0.11 M at the peak. Considering GLUT expression is up-regulated by various physiological biochemical conditions such as hypoxia, glucose starving and chemical compounds, the concentration of intracellular glucose compounds can be controlled to the desired condition.

Viability Assessment after Glucose Loading

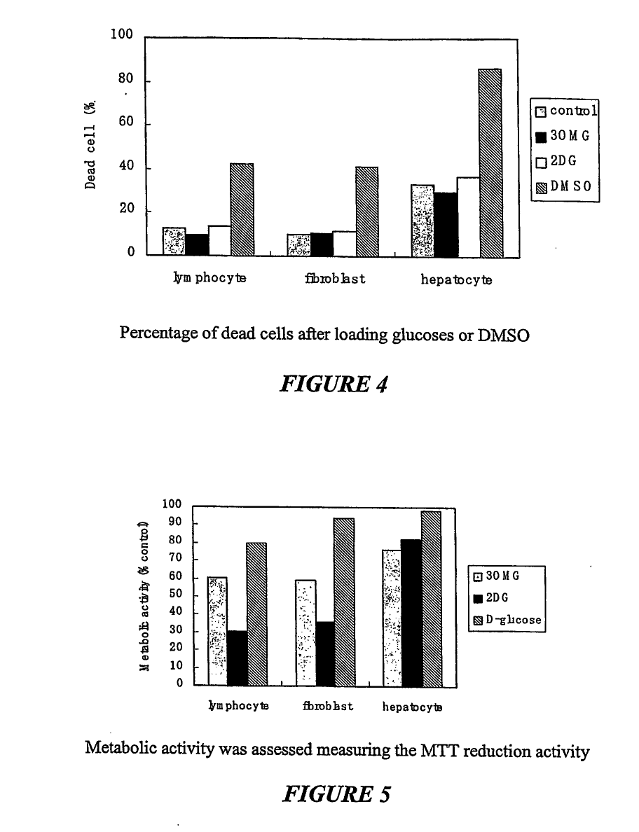

The conventional permeable cryoprotectants such as DMSO and glycerol benefit cells for preservation, but they are known to be toxic to the cells at the same time. Non-metabolizable glucose compounds are considered to be less toxic because they are metabolically inactive, yet high accumulation of D-glucose may harm glycolysis and glycogen synthesis. The toxicity of various glucose compounds, D-glucose and DMSO was examined after loading. Cells were incubated with glucose-free DMEM supplemented with 0.2 M 3OMG, with 0.2 M 2DG or 1.4 M DMSO for 60 min at 37° C. After loading, calcein and ethidium homodimer were added to cell suspensions to assess viability. Cells were run through Beckton-Dickinson FACSCalibur flowcytometer to take emission reading at 530 nm and 630 nm of 5000 particles. High green and low red fluorescence (calcein positive) were scored as live, whereas high red and low green (ethidium positive) were scored dead. FIG. 4 showed the percentage of dead cells after incubation with glucose compounds or DMSO. None of the glucose compounds showed toxicity to the cells, yet DMSO showed significant toxicity in all kinds of cells.

Change of Metabolic Activity after Glucose Loading

The data showed that these non-metabolizable compounds were not toxic as DMSO. However, it was considered to be possible that high accumulation of glucose compounds change metabolic activity of the cells. Therefore, metabolic activity after sugar loading was measured with the MTT assay. MTT assay is a colorimetric assay based on the activity of mitochondrial dehydrogenase activity. The MTT assay measures the ability of cells to metabolize 3-(4,5-dimethyldiazol-2-yl)-2,5-diphenyl tetrazolium 6 bromide (MTT). Cells were seeded on 96-well culture plates with 100 μL defined medium supplemented with various glucose compounds according to the experimental design for 1 hr at 37° C. At the end of the treatment period, 10 μL of MT solution (5 mg/mL) were added and incubated for 2 hrs at 37° C. At this time, 100 μL of detergent solution were added to the wells and after 24 hrs of incubation at 25° C., and the absorption value at 570 nm was measured in a microtiter reader.

As shown in FIG. 5, metabolic activity was slightly decreased with 3OMG loading in all cells, although viability of cells did not change after glucose loading. This metabolic down-regulation occurred probably due to glucose starvation. On the other hand, significant loss of metabolic activity was found after 2DG loading in lymphocytes and fibroblasts but not in hepatocytes. Primary isolated hepatocytes are not down-regulated by 2DG because 2DG is known to exclusively affect proliferating cells (Aft et al (2002) Supra). Down-regulation of metabolic activity is also reported to be protective to the cells during storage. Glucose compounds are thought to protect cells from protein and membrane damage, but metabolic down-regulation could be added value for the preservation. The present results show different effects on metabolism with different compounds. Thus different compounds can be chosen and combined according to the biomaterial being preserved.

Cryopreservation with Non-Metabolizable Glucose Compounds

This example shows that these non-metabolizable glucose compounds were suitable for the practice of preservation of biomaterial. At first, these compounds were tested on cryopreservation, which is most common protocol for preservation of biomaterials. Glucose compounds are thought to prevent damaging effects of protein and lipid-membranes during storage. In addition, glucose compounds have a high glass transition temperature and cause the formation of stable glasses during storage. Cells were incubated with glucose-free DMEM or glucose-free DMEM with 0.2 M 2DG, or 0.2 M 3OMG for 60 min at 37° C. After loading, cell suspensions were transferred to 1.0 ml of Cryogenic Vials and placed in a controlled-rate freezer. Samples were then cooled at −1° C./min to −7° C., at which temperature the vials were seeded to induce the formation of extracellular ice followed by a 10 min holding period. Next, samples were cooled at −1° C./min to −80° C., and then transferred to liquid nitrogen (−196° C.) for storage. Samples were stored for up to 14 days. Following storage, samples were rapidly thawed in 37° C. H₂O for 80 sec with gentle agitation. The samples were then diluted to 1:10 in DMEM and incubated for 10 min. Samples were then centrifuged, supernatant decanted, and cells were resuspended in culture medium. The viability of cryopreserved hepatocytes was determined immediately after thawing using the trypan blue exclusion assay and quantitated using a hemocytometer.

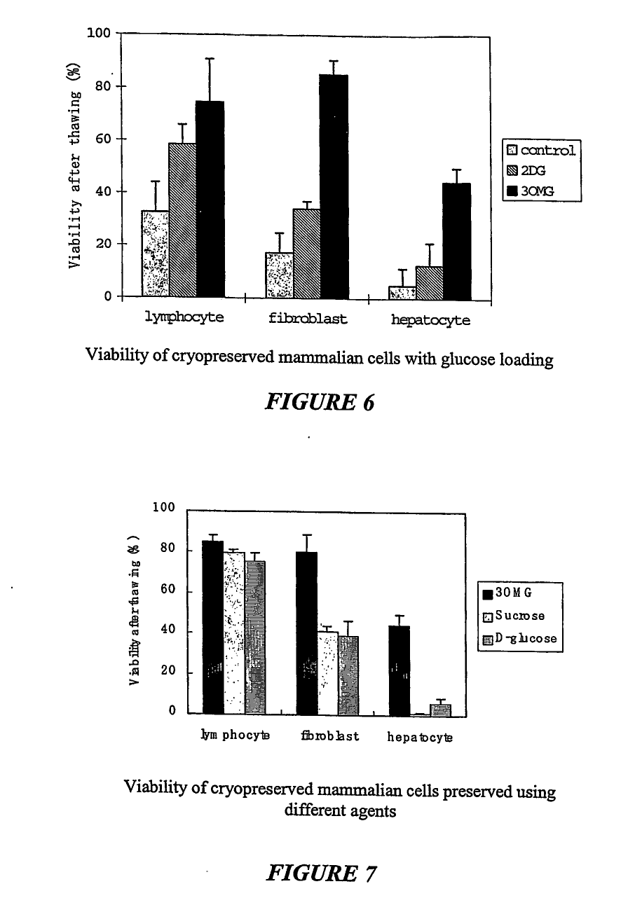

Mammalian cells were cryopreserved after loading 2DG or 3OMG, and significantly high viability was obtained with glucose loading compared to non-glucose control in murine B lymphocytes, murine fibroblasts, and rat primary hepatocytes (FIG. 6). The results also showed 3OMG was more protective than 2DG probably due to some metabolic damage to the cells by loading 2DG. Cryopreservation was also tested using sucrose and D-glucose (FIG. 7). Sucrose was used as a non-permeable (non-transportable) control, and D-glucose was used as metabolisable control. In fibroblast and hepatocytes, 3OMG showed better survival compared to sucrose and D-glucose, while there was no difference in B lymphocytes. These results demonstrate that 3OMG has better protective function because it accumulates inside cells, and because it is non-metabolizable and transportable through cell membrane. To note, intracellular sugar is considered to be indispensable for preservation of primary hepatocytes.

Desiccation with Non-Metabolizable Glucose Compounds

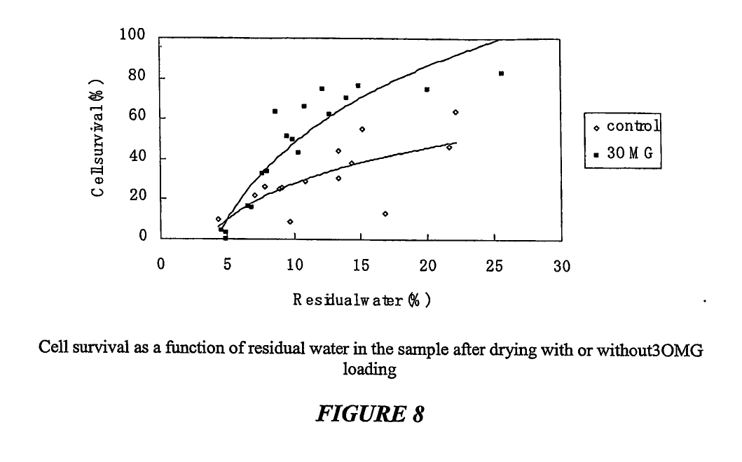

Cryopreservation is now used extensively for long-term storage, but it is very cumbersome to store, handle, and transport samples at cryogenic temperature. So desiccation is considered to be able to be an alternative preservation technique for biomaterials, although it has not well documented yet. Accordingly, mammalian cells were dried after loading non-metabolizable glucose compounds. Cells were incubated with glucose-free DMEM or glucose-free DMEM with 0.2 M 3OMG for 60 min at 37° C. After loading 3OMG, 180 μl of cell suspensions were plated on petri dish and dish were plated in an airtight acrylic box equilibrated with CaSO₄/CoCl₂ desiccant for different length of time. After drying, cells were rehydrated by adding warm culture medium and incubated for 24 hrs. To determine cell survival, membrane integrity assay using SYTO 13/ethidium bromide was used. The ratio of intact cells between dried and non-dried (control) samples was calculated as cell survival. As shown in FIG. 8, cell survival was significantly higher with 3OMG group at any moisture condition.

### Example 2

### Preservation of Hepatocytes

Cell Culture

Rat primary hepatocytes were isolated from female Lewis rats (Charles River Laboratories, Wilmington, Mass.) by a procedure previously described. Typically, about 2.0×108 cells were isolated from a single isolation and the viability judged by trypan blue exclusion was 91.4±2.4%. All animal procedures were performed in accordance with National Research Council guidelines and approved by the subcommittee on Research Animal Care at the Massachusetts General Hospital. Hepatocyte culture conditions were described elsewhere.

Uptake of 3OMG

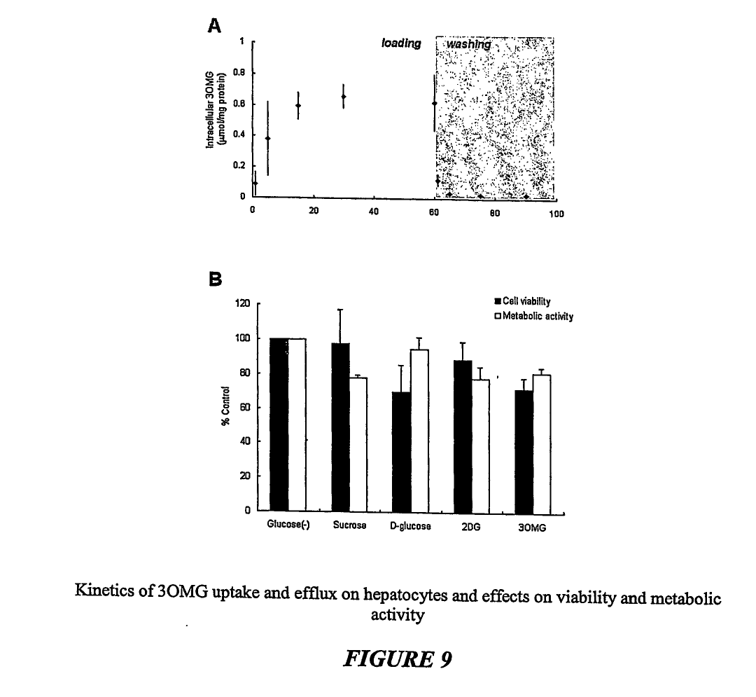

The amount of intracellular 3OMG loading by hepatocytes was examined using tritium labeled 3OMG Significant amount of 3OMG was taken rapidly into cells, and a plateau of 62 mmol/mg total protein was reached within approximately 30 min (FIG. 9A). By incubation in glucose-free medium, intracellular 3OMG was washed out within approximately 10 min to nearly 0 mmol/mg total protein (FIG. 9A). The intracellular 3OMG concentration was estimated from the cell number and the mean osmotically active isotonic volume, assuming an equal internal distribution of 3OMG The osmotically active isotonic volume is a theoretical value representing the volume of water that can be removed from a cell if it is replaced in an infinitely concentrated solution. The calculated concentration of intracellular 3OMG after 60 min of loading was 165.0±34.1 mM (Table 1), which roughly corresponded to the concentration of 3OMG in the extracellular solution (200 mM).

TABLE 1
The intracellular concentration of 3OMG in
hepatocytes after loading with 200 mM 3OMG
containing medium and washing with sugar-free medium.

| | loading (60 min) | washing (30 min) |
|---|---|---|
| Measured sugar (μmol/mg protein) | 0.62 ± 0.13 | 0.02 ± 0.01 |
| Calculated concentration (mM) | 165.0 ± 34.1 | 6.6 ± 2.7 |

Measurement of Glucose Uptake

Isotonic uptake solution containing 200 mM 3OMG (3-O-methyl-glucose, Sigma, St. Louis, Mo.) were prepared by diluting the D-glucose-free DMEM (Gibco, Gaithersburg, Md.) with distilled water to reduce solution osmolality to 310 mOsm/kg. Isolated hepatocytes were pelleted by centrifugation at 250×g for 5 min and the supernate decanted. Uptake was initiated by adding warm uptake solution with 10 mCi/ml (0.16 mM) 3-O-methyl-3H-D-glucose (Perkin Elmer, Boston, Mass.) to obtain 2×106 cells/ml. Cells were incubated at 37° C. and samples were taken at 1, 5, 15, 30, and 60 min. At 60 min, the remaining cells were collected by centrifugation at 250×g for 5 min, supernate decanted, and resuspended with warm D-glucose-free DMEM to wash out intracellular 3OMG. Washed cells were incubated at 37° C. and samples were taken at 1, 5, 15, 30 min. The uptake and efflux were terminated by dilution with a 20-fold excess of cold PBS supplemented with 100 mM phloretin (Sigma) to block transport 40. Cells were immediately collected on a wet membrane filter (1.2 mm pore, Millipore, Billerica, Mass.) and washed with 20 ml of the above cold blocking solution. Cell-associated radioactivity was assessed in 7 ml of Ultima Gold LSC-cocktail Packard BioScience, Meriden, Conn.) using a Beckman LS 6000IC Scintillation Counter (Beckman Coulter, Fullerton, Calif.). Total protein was determined using the micro protein determination kit (Sigma).

Cellular Viability and Metabolic Activity after Sugar Loading

Cellular viability of hepatocytes after sugar loading was examined in order to evaluate the toxicity. The viability showed no significant differences among cells incubated with sucrose, D-glucose, 2DG, and 3OMG (FIG. 9B). A MTT assay, a colorimetric analysis based on the activity of mitochondrial dehydrogenase, was also performed on cells incubated with various sugars. Equal numbers of the cells were used for the MTT assay, so this assay was considered to reflect metabolic activity as well as cellular viability. The metabolic activity of hepatocytes was approximately 80-90% of no-sugar control after incubation with sucrose, D-glucose, 2DG, and 3OMG indicating that the sugar manipulations were minimally toxic to primary hepatocytes (FIG. 9B).

Viability Assay

Cells were incubated with isotonic D-glucose-free DMEM supplemented with 200 mM D-glucose, 200 mM 3OMG, or 200 mM 2DG (Sigma) for 60 min at 37° C. to load sugar. Viability after incubation was determined using LIVE/DEAD® Viability/Cytotoxity kit (Molecular Probes, Eugene, Oreg.). Cells were collected by centrifugation, and resuspended in PBS containing 0.8 μM calcein AM and 2 μM ethidium homodimer-1 and incubated for 15 min at ambient temperature. Viable cells were quantified using a Beckton-Dickinson FACSCalibur flowcytometer (San Jose, Calif.) as described elsewhere. The viability was shown as percentage of glucose-free control.

MTT Assay

MTT (3-(4,5-dimethyldiazol-2-yl)-2,5-diphenyl tetrazolium 6 bromide) assay was done using MT Cell Proliferation Assay kit (American Type Culture Collection, Manassas, Va.). Hepatocytes were seeded on collagen-coated 96-well culture plates with 100 μL isotonic D-glucose-free DMEM medium supplemented with 200 mM 3OMG or 2DG for 60 min at 37° C. Cells incubated with D-glucose free DMEM without supplement was used as control. At the end of each treatment, 10 μL of MTT solution (5 mg/ml) was added and the cells incubated for 2 hrs at 37° C. Detergent solution (100 μL) was added, the samples were incubated overnight at 25° C., and the absorption at 570 nm was measured in Thermomax microplate reader (Molecular Devices, Sunnyvale, Calif.).

Cryopreservation and Thawing

Isolated hepatocytes were incubated with isotonic D-glucose-free DMEM with 200 mM 3OMG, 2DG, sucrose, or D-glucose for 60 min at 37° C. as described above. Cells incubated with D-glucose free DMEM without supplement was used as control. Following incubation, cells were pelleted by centrifugation for 5 min, supernate decanted, and resuspended in cold HypoThermosol® solution (HTS) (Biolife Solutions Inc., Binghamton, N.Y.) with 200 mM 3OMG, 2DG, sucrose, or D-glucose (1×10⁶ cells/ml). HTS without sugar supplement was used for control samples. Cell suspensions were transferred to 1.0 ml of Cryogenic Vials (Nalge Company, Rochester, N.Y.) and placed in a controlled-rate freezer (KRYO 10, Planer, Middlesex, UK). Samples were then cooled at −1° C./min to ˜6° C., at which temperature the vials were seeded to induce the formation of extracellular ice by application of cold forceps to the exterior of the cryovials followed by a 10 min holding period. Next, samples were cooled at −1° C./min to −80° C., and then transferred to liquid nitrogen (−196° C.) for storage for 1-7 days. Following storage, samples were rapidly thawed in 37° C. H₂O for 2 min with gentle agitation. The samples were then diluted to 1:10 in D-glucose-free DMEM and incubated for 10 min at 37° C. to wash out loaded sugar compounds. Samples were then centrifuged, supernatant decanted, and resuspended in culture medium. The viability of cryopreserved cells was determined immediately after thawing using the trypan blue exclusion assay and expressed as a percent of the unfrozen control otherwise treated identically.

Effects of Glucose Compounds on Viability and Attachment of Cryopreserved Hepatocytes

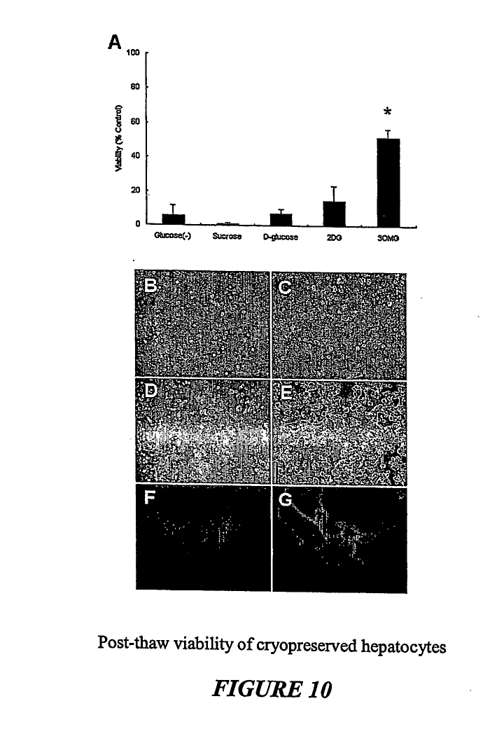

To evaluate the beneficial effects of non-metabolizable glucose compounds during cryopreservation, we measured the post-thaw viability of sugar-loaded hepatocytes as compared to respective non-frozen samples. Controls were cells incubated in glucose-free DMEM (no-sugar control), sucrose (non-permeable/non-intracellular control), and D-glucose (permeable but metabolizable control). The post-thaw viabilities of all controls were extremely low (<10%). The 2DG-loaded hepatocytes showed somewhat greater viability (15%). On the other hand, 3OMG-loaded cells showed by far the best viability (>50%) among all groups with statistically significant differences (p<0.01) (FIG. 10A). To examine the attachment efficiency, frozen-thawed hepatocytes were seeded on a collagen gel. No-sugar control, sucrose-, and D-glucose-loaded hepatocytes rarely attached, remained spherical, and eventually died (FIG. 10B, 10C, 10D), whereas 3OMG-loaded primary hepatocytes attached, spread, and adopted the typical cuboidal shape of normal fresh hepatocytes (FIG. 10E). Moreover, hepatocytes cryopreserved without sugar completely lost their cellular polarity and cytoskeletal organization (FIG. 10F), while 3OMG-loaded hepatocytes showed normal localization of actin filaments (F-actin) at lateral intercellular contacts and apical canalicular membrane (FIG. 10G).

Fluorescence Staining of Actin Filament

Hepatocytes cultured in a sandwich culture were fixed using 4% paraformaldehyde (PFA) for 30 min, followed by permeabilization for 5 min in 0.1% Triton X-100 (Sigma). Cells were stained for 30 min with 3 mM rhodamine phalloidin (Molecular Probes) in PBS with 1% bovine serum albumin (BSA) (Sigma). Following incubation, the samples were visualized with use Zeiss Axiovert 200 inverted microscope equipped with Cy 3.5 filter sets (Carl Zeiss, München-Hallbergmoos, Germany), and images were captured with AxioVision 4.0 software (Carl Zeiss).

Long-Term Function of Hepatocytes after Cryopreservation

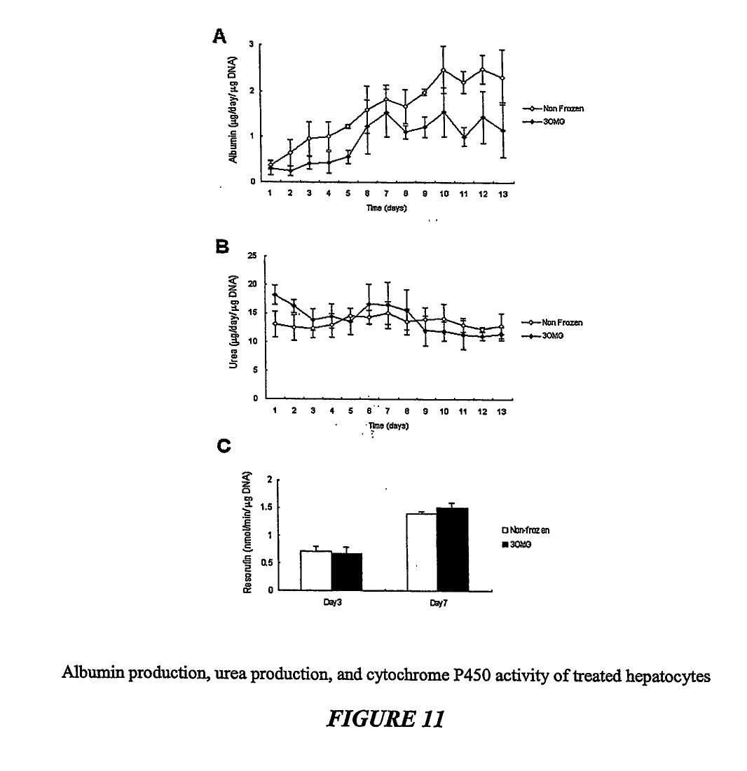

To demonstrate that cryopreserved hepatocytes retain their function, we seeded frozen-thawed hepatocytes in a collagen sandwich culture and measured hepatospecific functions for 14 days. The sandwich culture is a long-term culture technique that results in stable and differentiated hepatocytes. We evaluated albumin synthesis, urea production, and cytochrome P450 (CYP) activity of frozen-thawed hepatocytes as markers of synthetic, metabolic, and detoxification abilities of hepatocytes. Albumin production of 3OMG-loaded and cryopreserved hepatocytes stabilized following 7 days in culture (FIG. 11A). Daily average of albumin production (day 7-13) from 3OMG-loaded hepatocytes was approximately 60% of non-frozen control (1.29±0.19 μg and 2.14±0.26 μg, respectively) with statistically significant difference (p=0.014). Urea synthesis of 3OMG-loaded and cryopreserved hepatocytes were comparable to those of non-frozen control hepatocytes (daily average; 12.85±1.84 μg and 13.58±0.74 μg, respectively) (FIG. 11B), and statistical analysis revealed no significant difference (p=0.51). The CYP activity was measured on day 3 and 7 after thawing. The activities by 3OMG-loaded and cryopreserved hepatocytes were equivalent to non-frozen control without statistically significant difference (FIG. 11C) (p>0.3). No-sugar control, sucrose-, and D-glucose-loaded hepatocytes completely lost these functions in 5 days, and all values were under detectable ranges.

Functional Assays of Hepatocytes after Cryopreservation

Hepatocytes (pre-frozen cell number: 2×10⁶ per dish were seeded and cultured in p35 dish with a collagen double-gel sandwich culture configuration immediately after thawing as described elsewhere. Culture medium was changed daily for 14 days and the collected media were saved for albumin and urea assays. Albumin concentration was analyzed by enzyme-linked immunosorbent assay (ELISA) as previously described. Urea concentration was determined via reaction with diacetyl monoxime using a standard blood urea nitrogen assay kit (Sigma). 3-Methylcholanthrene (3-MC) (Sigma) induced CYP activities were assessed based on the time dependent formation of resorufin from ethoxy-resorufin due to isoenzyme P4501A1 activity (EROD assay) as described elsewhere. 3MC induced hepatocyte cultures received 2 ml of medium containing 2 μM of 3-MC 48 hrs prior to the assay on day 3 and 7. Rate of formation of resorufin, as calculated from the early linear increase in the fluorescence curve (resorufin versus time), was defined as CYP activity and expressed as nmol/min. The DNA content of each dish was determined at the end of the culture period and values were calculated per μg DNA to normalize them to the number of viable hepatocytes.

Statistics and Data Analysis

Each experiment was performed at least 3 times in triplicate. Data are expressed as means±standard errors. Statistical significance was calculated using a two-tailed Student t-test for paired data and Analysis of variance (ANOVA) as applicable. The threshold for statistical significance was considered p<0.05.

### CONCLUSION

In summary, as shown by the results of preservation, these non-metabolizable glucose compounds have beneficial effects for preservation of mammalian cells. To note, there are several applications for this invention. First, this invention can be applicable to all kinds of biomaterials. Glucose compounds are transported into cells through GLUT, and all kinds of mammalian cells physiologically have GLUT. So these compounds are practically possible to be loaded to any biomaterials such as tissues and organs as well as cells without any specific equipment. Furthermore, these compounds are similar to D-glucose and their toxicity is not evident as conventional cryoprotectant, so they could be used for an in vivo protocol. Therefore, using cryopreservation, hypothermic storage or desiccation, this method can be applied for various kinds of preservation protocols including transplantation. Second, there are various kinds of non-metabolizable sugar compounds other than 3OMG and 2DG. As the ability of protection and metabolic affect for the cells are different among different compounds, it would be possible to use the appropriate single compound, or combined compounds on various kinds of biomaterials.

Regarding the preservation of hepatocytes, the results demonstrate that 3OMG, a non-metabolizable glucose compound, can be an efficient CPA for hepatocytes. The advantages of using 3OMG are several-fold: (1) 3OMG can be easily introduced into and washed out from cells in single steps, whereas the traditional CPAs require cumbersome stepwise addition and dilution steps, (2) 3OMG is not toxic to hepatocytes, and (3) 3OMG works at much lower concentration (<200 mM) than the conventional CPAs (1-2 M).

Measurements showed 165 mM of intracellular 3OMG in hepatocytes, and the concentration roughly corresponded to that in the extracellular solution (200 mM). The calculated intracellular concentration of 3OMG might be slightly different from actual concentration in the cells because of the errors in total and inactive cell volume estimations. The invention thus establishes a novel cryopreservation strategy by mimicking natural cryoprotective adaptations in the sense that 200 mM extracellular glucose is rapidly transported by high capacity transporter GLUT-2 into hepatocytes.

Cryopreservation of primary hepatocytes is still a challenging strategy despite increasing demands and much effort with the limited supply of available hepatocytes. There have been only a few studies in which both high yield of recovery and maintenance of long-term functions were reported. In long-term culture, only 3OMG-loaded hepatocytes showed enhanced long-term survival and maintenance of hepatospecific functions (albumin synthesis, urea production, and cytochrome P450 detoxification) comparable to non-frozen controls. These results indicate that 3OMG protects cell and organelle structures and enzymatic activities required to complete these complex biochemical processes.

It will be understood that the foregoing is only illustrative of the principles of the invention, and that various modifications can be made by those skilled in the art without departing from the scope and spirit of the invention including combinations and subcombinations of the features described above and in incorporated documents. All references cited herein are expressly incorporated by reference in their entirety.

1. A method for preserving a biomaterial, the method comprising:
a) exposing a biomaterial having a membrane and at least one transporter molecule to a preservation agent, the transporter molecule being effective to transport the preservation agent across the membrane to load the biomaterial with the preservation agent to a desire concentration sufficient for preserving the biomaterial;
b) preparing the preservation agent loaded biomaterial for storage in a preserved state.

2. The method of claim 1, wherein the step of preparing the preservation agent loaded biomaterial for storage in a preserved state includes at least one selected from the group consisting of freezing, drying, and freeze-drying the biomaterial.

3. The method of claim 1, wherein the step of preparing the preservation agent loaded biomaterial for storage in a preserved state includes drying the biomaterial.

4. The method of claim 3, wherein the drying is accomplished by at least one selected from the group consisting of air drying, vacuum drying, and desiccation.

5. The method of claim 1, further comprising:
c) storing the preservation agent loaded biomaterial.

6. The method of claim 5, wherein the preservation agent loaded biomaterial is stored in a frozen state.

7. The method of claim 5, wherein the preservation agent loaded biomaterial is stored in a dry state.

8. The method of claim 5, further comprising:
d) recovering at least a portion of the preservation agent loaded biomaterial in a viable state.

9. The method of claim 8, wherein the step of recovering includes removing the preservation agent from the biomaterial.

10. The method of claim 1, wherein the biomaterial is selected from the group consisting of organs, tissues, cells, stem cells, cell-lines, bone marrow, embryos, platelets, fibroblasts, lymphocytes, hepatocytes, osteoblasts, spermatozoa, granulocytes, red blood cells, dendritic cells, oocytes, and plant cells.

11. The method of claim 1, wherein the biomaterial includes mammalian cells.

12. The method of claim 11, wherein the biomaterial includes hepatocytes.

13. The method of claim 1, wherein the transporter molecule is a selected from the group consisting of a glucose transporter protein (GLUT), a sucrose transporter protein, a mannose transporter protein, a galactose transporter protein, and a hexose transporter protein.

14. The method of claim 1, wherein the transporter molecule is a glucose transporter protein (GLUT).

15. The method of claim 1, wherein the non-metabolizable preservation agent is a non-metabolizable carbohydrate.

16. The method of claim 15, wherein the non-metabolizable carbohydrate is selected from the group consisting of 3-O-methyl-glucose (3OMG), 2-deoxy-glucose (2DG), 6-deoxy-glucose (6DG), methyl α-D-glucoside, methyl β-D-glucoside, 1,6-anhydro-β-D-glucose, and 1,5-anhydro-D-glucitol.

17. The method of claim 15, wherein the non-metabolizable preservation agent is 3-O-methyl-glucose (3OMG).

18. The method of claim 15, wherein the non-metabolizable preservation agent is 2-deoxy-glucose (2DG).

19. A method for preserving one or more mammalian cells, the method comprising:
a) exposing one or more mammalian cells having a membrane and at least one transporter protein to a non-metabolizable preservation agent, the transporter protein being effective to transport the non-metabolizable preservation agent across the membrane to load the mammalian cells with the non-metabolizable preservation agent to a desired intracellular concentration sufficient for preserving the mammalian cells;
b) preparing the preservation agent loaded mammalian cells for storage in a preserved state;
c) storing the preservation agent loaded mammalian cells in a preserved state; and
d) recovering at least a portion of the preservation agent loaded mammalian cells to a viable state.

20. The method of claim 19, wherein the mammalian cells comprise nucleated mammalian cells.

21. The method of claim 19, wherein the mammalian cells include at least one selected from the group consisting of organ cells, tissue cells, stem cells, cell-lines, bone marrow cells, embryo cells, platelets, fibroblasts, lymphocytes, hepatocytes, osteoblasts, granulocytes, red blood cells, and dendritic cells.

22. The method of claim 19, wherein the mammalian cells comprise hepatocytes.

23. The method of claim 19, wherein the step of preparing the preservation agent loaded mammalian cells for storage in a preserved state includes at least one selected from the group consisting of freezing, drying, and freeze-drying.

24. The method of claim 19, wherein the step of preparing the preservation agent loaded mammalian cells for storage in a preserved state includes drying.

25. The method of claim 24, wherein the drying is accomplished by at least one selected from the group consisting of air drying, vacuum drying, and desiccation.

26. The method of claim 19, wherein the transporter protein is a selected from the group consisting of a glucose transporter protein (GLUT), a sucrose transporter protein, a mannose transporter protein, a galactose transporter protein, and a hexose transporter protein.

27. The method of claim 19, wherein the transporter protein is a glucose transporter protein (GLUT).

28. The method of claim 19, wherein the non-metabolizable preservation agent is a non-metabolizable carbohydrate.

29. The method of claim 28, wherein the non-metabolizable carbohydrate is selected from the group consisting of 3-O-methyl-glucose (3OMG), 2-deoxy-glucose (2DG), 6-deoxy-glucose (6DG), methyl α-b-glucoside, methyl β-D-glucoside, 1,6-anhydro-β-D-glucose, and 1,5-anhydro-D-glucitol.

30. The method of claim 28, wherein the non-metabolizable preservation agent is 3-O-methyl-glucose (3OMG).

31. The method of claim 28, wherein the non-metabolizable preservation agent is 2-deoxy-glucose (2DG).

32. The method of claim 19, wherein the desired intracellular concentration of non-metabolizable preservation agent is less than or equal to about 1.0 M.

33. The method of claim 19, wherein the desired intracellular concentration of non-metabolizable preservation agent is less than or equal to about 0.4 M.

34. The method of claim 19, wherein the desired intracellular concentration of non-metabolizable preservation agent is less than or equal to about 0.2 M.

35. The method of claim 19, wherein the mammalian cells are preserved in a frozen state.

36. The method of claim 19, wherein the mammalian cells are preserved in a dry state.

37. A method for preserving one or more nucleated mammalian cells, the method comprising:
a) exposing one or more nucleated mammalian cells having a membrane and at least one transporter protein to a preservation agent comprising a non-metabolizable carbohydrate, the transporter protein being effective to transport the non-metabolizable carbohydrate across the membrane to load the nucleated mammalian cells with the non-metabolizable carbohydrate to a desired intracellular concentration sufficient for preserving the mammalian cells;
b) preparing the preservation agent loaded nucleated mammalian cells for storage in a preserved state by a method selected from the group consisting of freezing, drying, and freeze-drying;
c) storing the preservation agent loaded nucleated mammalian cells in a preserved state, the preservation agent loaded nucleated mammalian cells being stored in a state selected from the group consisting of a dry state and a frozen state; and
d) recovering at least a portion of the preservation agent loaded mammalian cells to a viable state.

38. The method of claim 37, wherein the transporter protein is a selected from the group consisting of a glucose transporter protein (GLUT), a sucrose transporter protein, a mannose transporter protein, a galactose transporter protein, and a hexose transporter protein.

39. The method of claim 37, wherein the transporter protein is a glucose transporter protein (GLUT).

40. The method of claim 39, wherein the non-metabolizable carbohydrate is selected from the group consisting of 3-O-methyl-glucose (3OMG), 2-deoxy-glucose (2DG), 6-deoxy-glucose (6DG), methyl α-D-glucoside, methyl β-D-glucoside, 1,6-anhydro-β-D-glucose, and 1,5-anhydro-D-glucitol.

41. The method of claim 39, wherein the non-metabolizable carbohydrate is 3-O-methyl-glucose (3OMG).

42. The method of claim 39, wherein the non-metabolizable carbohydrate is 2-deoxy-glucose (2DG).

43. The method of claim 37, wherein the desired intracellular concentration of non-metabolizable carbohydrate is less than or equal to about 1.0 M.

44. The method of claim 37, wherein the desired intracellular concentration of non-metabolizable carbohydrate is less than or equal to about 0.4 M.

45. The method of claim 37, wherein the desired intracellular concentration of non-metabolizable carbohydrate is less than or equal to about 0.2 M.

46. A mammalian cell prepared for preservation comprising:
a cell membrane;
a non-metabolizable carbohydrate loaded to a desired intracellular concentration sufficient to preserve the cell; and
a transporter protein effective to transport the non-metabolizable carbohydrate across the membrane to load the mammalian cell with the non-metabolizable carbohydrate to the desired intracellular concentration;
wherein the mammalian cell is in a state selected from the group consisting of frozen and dry.

47. The cell of claim 46, wherein the transporter protein is a selected from the group consisting of a glucose transporter protein (GLUT), a sucrose transporter protein, a mannose transporter protein, a galactose transporter protein, and a hexose transporter protein.

48. The cell of claim 46, wherein the transporter protein is a glucose transporter protein (GLUT).

49. The cell of claim 48, wherein the non-metabolizable carbohydrate is selected from the group consisting of 3-O-methyl-glucose (3OMG), 2-deoxy-glucose (2DG), 6-deoxy-glucose (6DG), methyl α-D-glucoside, methyl β-D-glucoside, 1,6-anhydro-β-D-glucose, and 1,5-anhydro-D-glucitol.

50. The cell of claim 48, wherein the non-metabolizable carbohydrate is 3-O-methyl-glucose (3OMG).

51. The cell of claim 48, wherein the non-metabolizable carbohydrate is 2-deoxy-glucose (2DG).

52. The cell of claim 46, wherein the desired intracellular concentration of non-metabolizable carbohydrate is less than or equal to about 1.0 M.

53. The cell of claim 46, wherein the desired intracellular concentration of non-metabolizable carbohydrate is less than or equal to about 0.4 M.

54. The cell of claim 46, wherein the desired intracellular concentration of non-metabolizable carbohydrate is less than or equal to about 0.2 M.

55. The cell of claim 46, wherein the mammalian cell is a nucleated mammalian cell.

56. The cell of claim 46, wherein the mammalian cell is selected from the group consisting of organ cells, tissue cells, stem cells, cell-lines, bone marrow cells, embryo cells, platelets, fibroblasts, lymphocytes, hepatocytes, osteoblasts, granulocytes, red blood cells, and dendritic cells.

57. The cell of claim 46, wherein the mammalian cell is a hepatocyte.
